(19) United States
(12) Patent Application Publication
(10) Pub. No.: US 2008/0223044 A1
(43) Pub. Date: Sep. 18, 2008

(54) Injection Apparatus for Cryogenic Engines

(76) Inventor: Peter Dearman, Bishops Stortford (GB)

Correspondence Address: BARNES & THORNBURG LLP, P.O. BOX 2786, CHICAGO, IL, 60690-2786, US

(21) Appl. No.: 11/994,434

(22) PCT Filed: Jun. 30, 2006
(86) PCT No.: PCT/GB06/02434

§ 371 Date: Jan. 2, 2008

(30) Foreign Application Priority Data
Jul. 1, 2005 (GB) 0513463.0

(51) Int. Cl. F01K 25/04; F15B 7/08; F15B 21/04

(52) U.S. Cl. 60/671; 60/531; 60/676; 60/589

(57) ABSTRACT

Injection apparatus is provided for injecting a drive fluid, such as liquefied nitrogen, into the working chamber (50) of a cryogenic engine. Liquefied nitrogen is admitted to a housing (36) of the apparatus under the control of an inlet valve (42) and expelled from the housing (36) under the control of an outlet valve (48). In the housing (36), heat is transferred to the liquid nitrogen to cause a small volume of the liquefied nitrogen to boil and thereby inject the drive fluid into the cryogenic engine under pressure. In each of two embodiments (FIGS. 1 to 7) the liquid nitrogen is transferred to a warmed region of the housing by a moveable injection member (4, 20) and in two further embodiments the housing is formed as a heat exchanger through which the nitrogen passes.

### FIELD OF THE INVENTION

This invention relates to injection apparatus for cryogenic engines.

### BACKGROUND TO THE INVENTION

The inventor's PCT specification WO 01/63099 discloses a cryogenic engine employing a liquefied gas (such as liquefied nitrogen) as the drive fluid. For efficient operation of the engine, the drive fluid must be supplied under pressure to the engine cylinder (or other working chamber in which the drive fluid expands to provide the shaft power). In many situations, for example where the cryogenic engine is used to power a motor road vehicle, it is not practical to store the drive fluid at high pressure, and the invention provides injection apparatus which takes drive fluid from a source at comparatively low pressure and supplies it at comparatively high pressure to the working chamber of a cryogenic engine.

### SUMMARY OF THE INVENTION

According to one aspect of the invention there is provided injection apparatus for injecting a drive fluid including a liquefied gas into a cryogenic engine, the apparatus comprising a housing, an inlet valve for controlling the admission of the drive fluid to an inlet region of the housing and an outlet valve for controlling the delivery of the drive fluid from an outlet region of the housing, the housing being such that heat is transferred to the drive fluid in its passage from the inlet region to the outlet region, causing a small volume of the drive fluid in the housing to boil and thereby inject the drive fluid through the outlet valve and into the cryogenic engine under pressure.

The inlet valve and the outlet valve preferably operate in timed relationship such that when the inlet valve opens to admit a charge of drive fluid the outlet valve is closed, after which the inlet valve closes, the pressure of the drive fluid within the housing rises and the outlet valve opens for the delivery of the drive fluid under pressure.

In one preferred embodiment the housing is formed as a heat exchanger for the passage of a heat exchange liquid in order to transfer heat from the heat exchange liquid to the drive fluid. The heat exchanger may be constituted by a plurality of pipes which extend through the housing and through which the heat exchange liquid is passed. The pipes may extend from the inlet region to the outlet region of the housing, the drive fluid occupying the space which is within the housing and which surrounds the pipes.

According to another aspect of the invention injection apparatus for injecting a drive fluid including a liquefied gas into a cryogenic engine comprises a housing, and an injection member moveable within the housing in order to displace the drive fluid from a first region of the housing to a second region of the housing, in use the drive fluid, in a liquefied condition, being admitted to the first region of the housing and transferred to the second region by movement of the injection member, the second region being at a higher temperature than the first region, causing a small volume of the drive fluid in the second region to boil and thereby inject the drive fluid into the cryogenic engine under pressure.

The drive fluid is preferably liquefied nitrogen but may be liquefied air, liquefied carbon dioxide or a mixture of any these gases. The low temperature is preferably in the range −200° C. to −180° C. with the higher temperature being ambient, typically between 10° C. and 20° C.

The injection member is preferably moveable within the housing in a repetitive sequence timed to be in appropriate synchronism with the working cycle of the cryogenic engine, which may follow a two-stroke or a four-stroke cycle. The injection apparatus may be driven by the cryogenic engine or may alternatively be driven by a separate power source, such as an electric motor. On startup, the apparatus may be primed by passing the liquefied nitrogen through the first region, in order to cool the latter.

The injection member is preferably reciprocatable within the housing, undergoing injection strokes and return strokes in alternate sequence. On an injection stroke, the member may move towards the second region, carrying a volume of drive fluid with it, and in this case the member may make sealing engagement with the housing and have a recess into which a volume of drive fluid is admitted at the first region and from which it is delivered at the second region.

Alternatively, the injection member may move towards the first region on an injection stroke, displacing the drive fluid from the first region to the second region, and in this case the housing is preferably equipped with inlet and outlet valves which open and close in timed manner to admit the drive fluid to the first region at the commencement of an injection stroke and allow egress of the drive fluid before the commencement of the return stroke.

The injection apparatus consumes little power which is conveniently obtained from the shaft power of the associated cryogenic engine.

The invention includes within its scope a cryogenic engine (eg as disclosed in the inventor's PCT specification WO 01/63099) associated with injection apparatus according to the invention.

### BRIEF DESCRIPTION OF THE DRAWINGS

Four embodiments of the invention will now be described, by way of example, with reference to the accompanying drawings, in which:

FIGS. 1 to 3 illustrate the first embodiment at three different stages in an operative cycle,

FIGS. 4 to 7 illustrate the second embodiment at four different stages in its operative cycle.

FIG. 8 illustrates the third embodiment in conjunction with part of cryogenic engine,

FIG. 9 is a sectional view on the line IX-IX of FIG. 8, and

FIGS. 10 and 11 correspond to FIGS. 8 and 9, but show the fourth embodiment.

### DETAILED DESCRIPTION OF THE DRAWINGS

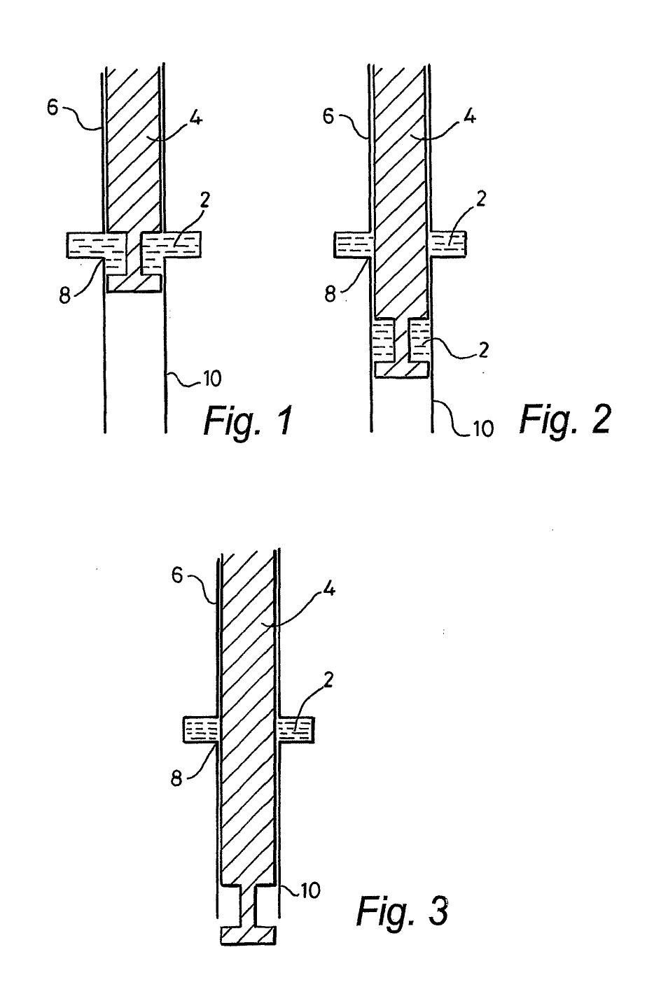

The injection apparatus of FIGS. 1 to 3 comprises an injection member in the form of a plunger 4 which reciprocates within a cylindrical housing 6 and makes sealing engagement therewith. The housing 6 has a first region 8 which is at −197° C. and a second region 10 which is at ambient temperature, typically between 10° C. and 20° C. The wall of the housing has a portion of increased diameter forming an annular inlet chamber, and the plunger has a portion of decreased diameter, forming a waisted region defining an annular volume.

The plunger 4 undergoes alternate injection and return strokes in order to take liquefied nitrogen 2 from a source thereof at low pressure and deliver it under pressure into the working chamber of a cryogenic engine.

To achieve this, the source of low pressure liquefied nitrogen is placed in communication with the annular inlet chamber. At the start of an injection stroke (FIG. 1), the annular inlet chamber and the waisted region in the plunger are in communication so the annular volume fills with liquefied nitrogen 2 at low pressure. The plunger 4 then moves downwardly within the housing 6 to undertake an injection stroke (FIG. 2), the plunger making sealing engagement with the housing wall so that the volume of nitrogen 2 within the chamber is carried with the plunger 4 from the region 8 towards the region 10. On reaching the region 10, a small amount of the transferred nitrogen boils as it is subjected to the higher temperature in the region 10, creating a source of high pressure which, at the end of the injection stroke where the chamber is no longer covered by the housing wall, drives the dose of liquid nitrogen into the chamber of the cryogenic engine (FIG. 3). It will be appreciated that the co-operative shaping and relative movement of the plunger 4 and the housing 6 define an inlet valve, for controlling admission of the nitrogen to the housing, and an outlet valve for controlling the exit of the nitrogen from the housing. When the inlet valve is open, the outlet valve is closed and vice versa.

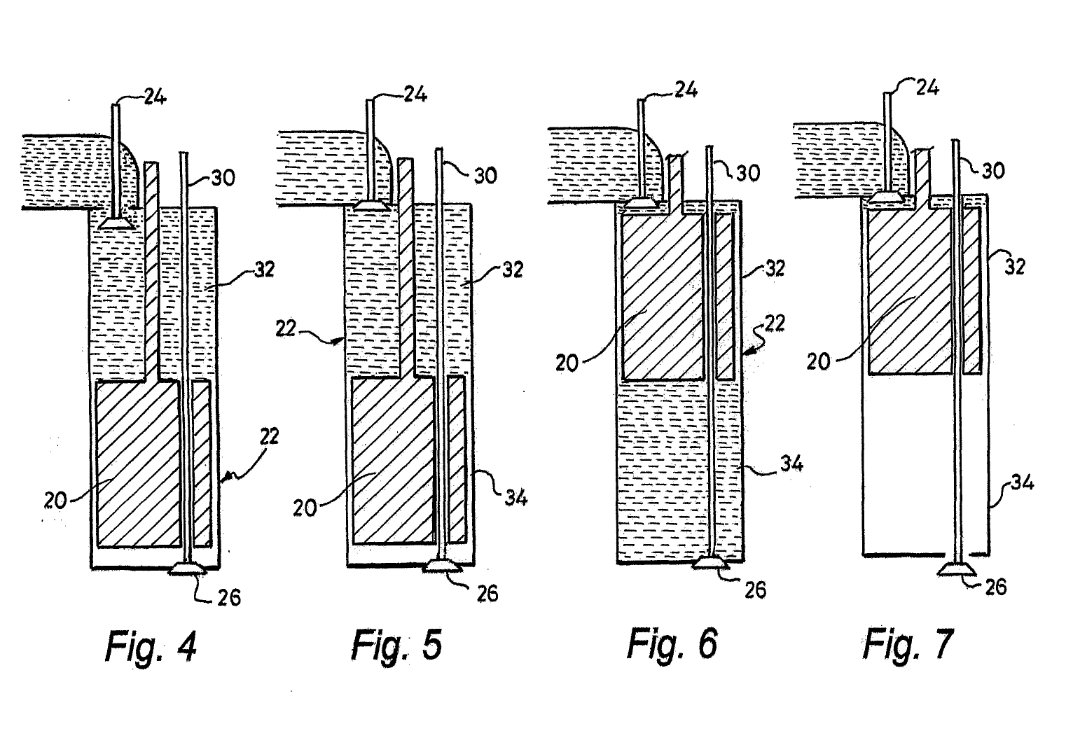

Referring to FIGS. 4 to 7, the second embodiment of injection apparatus comprises a plunger 20 reciprocatable, with clearance, in a cylindrical housing 22 having an inlet valve 24 for controlling admission of low pressure liquefied nitrogen from a source thereof, and an outlet valve 26 for controlling flow of high pressure liquid nitrogen from the housing 22 to the working chamber of a cryogenic engine. The valve 26 has a valve stem 30 which passes through a passage in the plunger 20.

At the commencement of an injection stroke (FIG. 4) the inlet valve 24 is open and the outlet valve 26 is closed, liquefied nitrogen at low pressure being admitted to a first region 32 within the housing at low temperature (−197° C.). The inlet valve 24 then closes and the plunger 20 commences an injection stroke, moving upwardly within the housing 22 towards the low temperature region 32 (FIG. 5). During the injection stroke of the plunger 20, the nitrogen is transferred by displacement from the low temperature region 32 to a second region 34 at ambient temperature. At the end of the injection stroke (FIG. 6) substantially all the nitrogen has been transferred and a small volume of nitrogen boils as a result of the higher temperature in the region 34. The resulting high pressure opens the outlet valve 26 and causes the liquefied nitrogen to be injected under high pressure into the working chamber of the cryogenic engine.

In each embodiment, the flow of liquefied nitrogen through the apparatus will maintain the first (low temperature) region at the required low temperature. The second (higher temperature) region will be maintained at the required higher temperature by drawing heat from the cylinder or casing of the cryogenic engine, or from being in contact with the heat exchange fluid. The apparatus may be driven by the cryogenic engine (eg. from the cam shaft thereof) or may be driven from a separate electric motor. The amount of liquefied gas entering the apparatus can be controlled (eg. by a valve) or by controlling the speed of the pump associated with the cryogenic engine.

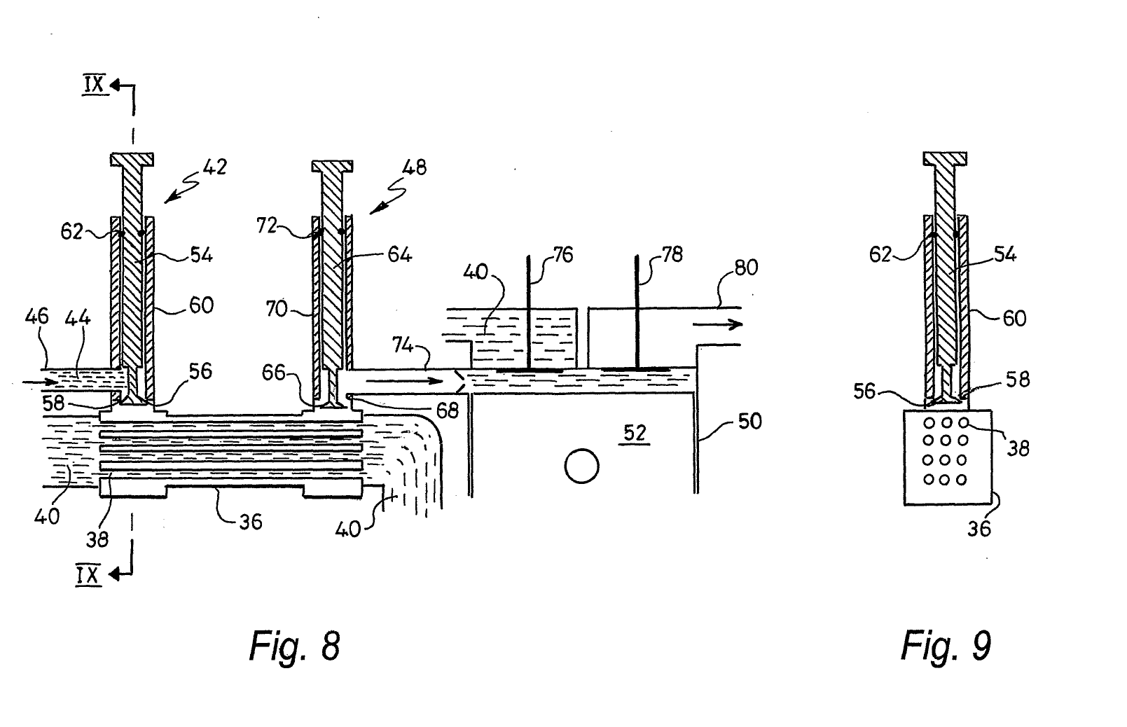

The injection apparatus shown in FIGS. 8 and 9 has a generally cylindrical housing 36 within which extends an array of twelve heat exchange pipes 38 through which passes a heat exchange liquid 40 such as ethylene glycol. At an inlet region of the housing, an inlet valve 42 controls the admission of liquefied nitrogen 44 which is supplied to the injection apparatus by a supply pipe 46 communicating with a pressurised storage tank holding a supply of liquid nitrogen at about minus 200° C. At an outlet region of the housing, an outlet valve 48 controls the delivery of nitrogen, now under pressure, to the cylinder 50 of a two-stroke cryogenic engine having a piston 52 reciprocatable within the cylinder 50.

The inlet valve 42 is formed by a movable valve member having an elongated stem 54 terminating at its lower end in a valve head 56 co-operating with a valve seating 58 on the lower end of a cylindrical guide 60. The valve member stem 54 slides within the guide 60 and is sealed with respect to the inner surface of the guide 60 by a circumferential seal 62. The supply pipe 46 communicates with the lower end of the guide 60, just above the valve seating 58.

Similarly, the outlet valve 48 has a moveable valve member with an elongated stem 64 terminating at its lower end in a valve head 66 co-operating with a valve seating 68 on the lower end of a cylindrical guide 70. The valve member stem 64 slides within the guide 70 and is sealed with respect to the inner surface of the guide 70 by a circumferential seal 72.

Just above the valve seating 68, an outlet pipe 74 communicates with the lower end of the guide 70, leading into the upper end of the cylinder 50. The upper end of the cylinder 50 has two valves, namely a valve 76 for admitting heat exchange liquid 40 to the cylinder 50 and a valve 78 for exhausting heat exchange liquid and drive fluid through an exhaust pipe 80. The cryogenic engine is a two-stroke engine and functions in the manner disclosed in WO 01/63099. The injection apparatus and cryogenic engine of FIGS. 8 and 9 operate in the following manner.

Commencing with the piston 52 at top dead centre (as illustrated in FIG. 8) the inlet valve 42 is closed, the outlet valve 48 opens and the two valves 76 and 78 are closed. A charge of drive fluid is forced from the housing 36 through the open outlet valve 48 and into the cylinder 50 where the drive fluid expands (whilst absorbing heat from the heat exchange liquid in the cylinder 50) to cause the piston 52 to undergo a power stroke to drive the crankshaft of the engine. Towards the end of the power stroke, as the piston 52 approaches bottom dead centre, the exhaust valve 78 opens and the outlet valve 48 remains open until the piston 52 is just beyond bottom dead centre, to reduce the pressure in the housing when the outlet valve closes. During the return stroke of the piston 52 the outlet valve 48 closes and, as soon as possible thereafter, the inlet valve 42 opens. This causes a charge of drive fluid to be admitted to the space, surrounding the pipes, within the housing 36. The heat exchange fluid 40 passing through the pipes 38 transfers thermal energy to the drive fluid, causing a small amount of drive fluid to boil so as to increase the pressure in the housing with the result that when the outlet valve 48 opens at the commencement of the next power stroke the drive fluid is injected into the cylinder under pressure. During the return stroke of the piston 52 the valve 76 opens to admit heat exchange liquid to the cylinders 50.

The described valve timings require the inlet and outlet valves 42 and 48 to undergo operative cycles at the same speed as the cryogenic engine. This places a considerable demand on the inlet valve 42, and to meet this problem the injection apparatus may be duplicated (or replicated any number of times). For example, a pair of injection apparatus, each as shown in FIGS. 8 and 9, may be arranged beside one another so as to supply a single cryogenic engine, each of the two apparatus then operating at half the speed which would be necessary if the engine were supplied by a single apparatus.

The heat exchange liquid supplied to the housing 36 is the same liquid as that supplied to the cylinder 50 through the inlet valve 76. The liquid supplied to the housing 36 is preferably taken, by means of a branched connection, from the main heat exchange liquid supplied to the cylinder, the liquid outlet from the housing 36 being fed back into the return of the heat exchange liquid after this has been exhausted from the cylinder 50. The inlet and outlet valve guides 60 and 70 and the stems 54 and 64 are elongated so that the seals 62, 72 can be located remotely from the low temperature regions at the lower ends of these valves.

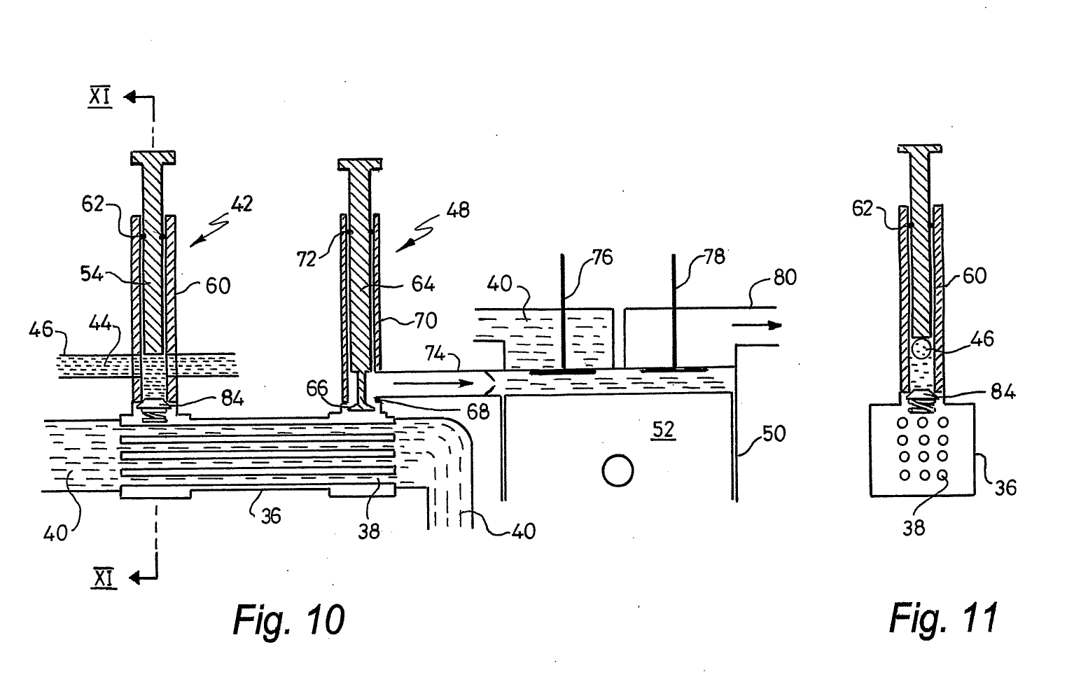

In the injection apparatus of FIGS. 10 and 11, parts corresponding to those of FIGS. 8 and 9 bear the same reference numerals. The areas of difference in FIGS. 10 and 11 are: the manner in which the supply pipe 46 continues past the guide 60; the increased spacing of the junction between the pipe 46 and the guide 60 above the lower end of the guide 60; and the formation of the inlet valve member as a spring-loaded check valve member 84 biased towards its closed position in which the check valve member 84 engages with the lower end of the guide 60. The inlet valve 42 is opened by downward movement of the stem 54 which not only traps a volume of drive fluid in the lower length of the guide 60 but also then forces open the check valve member 84 so as to press this volume of drive fluid into the housing 36.

The supply pipe 46 is continued beyond the guide 60, leading the liquid nitrogen back to the storage tank under the influence of a small re-circulating pump, preferably located in the storage tank. This low speed circulation reduces the tendency for bubbles to form in the nitrogen.

After entering the housing 36, the nitrogen receives heat from the heat exchanger so that a small portion boils, driving the nitrogen through the outlet valve 48 and into the cylinder 50, in the manner described with reference to FIGS. 8 and 9.

1. Injection apparatus for injecting a drive fluid including liquefied gas into a cryogenic engine, the apparatus comprising a housing, an inlet valve for controlling the admission of the drive fluid to an inlet region of the housing and an outlet valve for controlling the delivery of the drive fluid from an outlet region of the housing, the housing being such that heat is transferred to the drive fluid in its passage from the inlet region to the outlet region, causing a small volume of the drive fluid in the housing to boil and thereby inject the drive fluid through the outlet valve and into the cryogenic engine under pressure.

2. Injection apparatus according to claim 1, wherein the inlet valve and the outlet valve operate in timed relationship such that when the inlet valve opens to admit a charge of drive fluid the outlet valve is closed, after which the inlet valve closes, the pressure of the drive fluid within the housing rises and the outlet valve opens for the delivery of the drive fluid under pressure.

3. Injection apparatus according to claim 1, wherein the housing is formed as a heat exchanger for the passage of a heat exchange liquid in order to transfer heat from the heat exchange liquid to the drive fluid.

4. Injection apparatus according to claim 3, wherein the heat exchanger is constituted by a plurality of pipes which extend through the housing and through which the heat exchange liquid is passed.

5. Injection apparatus according to claim 4, wherein the pipes extend from the inlet region to the outlet region of the housing, the drive fluid occupying the space which is within the housing and which surrounds the pipes.

6. Injection apparatus according to claim 1, wherein the inlet valve is constituted by a valve member biased against a valve seating, and a plunger slideable between a withdrawn position, corresponding to a closed position of the inlet valve, and an extended position in which the plunger engages the valve member to move it away from the valve seating, corresponding to an open position of the inlet valve.

7. Injection apparatus for injecting a drive fluid including a liquefied gas into a cryogenic engine, the apparatus comprising a housing, and an injection member moveable within the housing in order to displace the drive fluid from a first region of the housing to a second region of the housing, in use the drive fluid, in a liquefied condition, being admitted to the first region of the housing and transferred to the second region by movement of the injection member, the second region being at a higher temperature than the first region, causing a small volume of the drive fluid in the second region to boil and thereby inject the drive fluid into the cryogenic engine under pressure.

8. Injection apparatus according to claim 7, wherein the member is moveable within the housing in a repetitive sequence timed to be in appropriate synchronism with the working cycle of the cryogenic engine.

9. Injection apparatus according to claim 8, wherein the member is reciprocatable within the housing, undergoing injection strokes and return strokes in alternate sequence.

10. Injection apparatus according to claim 9, wherein on an injection stroke, the member moves towards the second region, carrying a volume of drive fluid with it, the member making sealing engagement with the housing and having a recess into which a volume of drive fluid is admitted at the first region and from which it is delivered at the second region.

11. Injection apparatus according to claim 9, wherein the injection member moves towards the first region on an injection stroke, displacing the drive fluid from the first region to the second region, and the housing being equipped with inlet and outlet valves which open and close in timed manner to admit the drive fluid to the first region at the commencement of an injection stroke and allow egress of the drive fluid before the commencement of the return stroke.

12. Injection apparatus according to claim 1 and in combination with a cryogenic engine.

13. The combination of claim 12, wherein the engine is supplied with driving fluid by a plurality of injection apparatus.

14. Injection apparatus according to claim 1 and in combination with a cryogenic engine, wherein the housing is formed as a heat exchanger for the passage of a heat exchange liquid in order to transfer heat from the heat exchange liquid to the drive fluid, and wherein the heat exchange liquid supplied to the heat exchanger is the same liquid as the heat exchange liquid supplied to the engine.
